(19) United States
(12) Patent Application Publication
(10) Pub. No.: US 2021/0053281 A1
(43) Pub. Date: Feb. 25, 2021

(54) DEVICE AND METHOD FOR CURING A PRINTED MATERIAL

(71) Applicant: The Regents of the University of Michigan, Ann Arbor, MI (US)

(72) Inventors: Kira BARTON, Ann Arbor, MI (US); Lai Yu Leo TSE, Ann Arbor, MI (US); Ethan McMILLAN, Grand Haven, MI (US)

(21) Appl. No.: 17/000,023

(22) Filed: Aug. 21, 2020

Related U.S. Application Data
(60) Provisional application No. 62/889,796, filed on Aug. 21, 2019.

(51) Int. Cl. B29C 64/188; B29C 64/268; B29C 64/245; B29C 64/209; B29C 64/364; B29C 64/227; B29C 64/129

(52) U.S. Cl. CPC B29C 64/188; B29C 64/268; B29C 64/245; B33Y 30/00; B29C 64/364; B29C 64/227; B29C 64/129; B29C 64/209

(57) ABSTRACT

A curing device delivers localized curing energy along a pattern of curable material printed over a substrate. A curing head of the device can emit a column of curing energy along an emission axis and toward a substrate carrying the pattern of curable material, and a movement system provides relative movement between the curing head and the substrate so that the column of curing energy is guided along the pattern. Localized delivery of the curing energy enables printing and curing of printed materials on low temperature substrates such as thermoplastics.

### TECHNICAL FIELD

The present disclosure relates generally to printing and is particularly applicable to curable printing fluids.

### BACKGROUND

Printing has evolved from a technique for producing readable text and graphic images, primarily for informational purposes, to a useful manufacturing process with a promising future. In particular, the ability to deposit a functional material onto a printing medium only at particularly specified locations can lead to a zero-waste and relatively fast additive manufacturing process when adapted to deposit materials other than traditional pigments or dyes. But difficulties with the deposition of materials having useful properties other than visual contrast with the printing medium continues to limit printing as a manufacturing process. This is partly because applicable printing technologies generally deliver fluidic materials to or toward the printing medium, while manufactured goods are typically formed from solid materials. In some cases, the transition of the printing fluid from fluidic to solid form either requires or is aided by heat, which limits the ability to print on substrates that soften, melt, or deform when heated.

### SUMMARY

In accordance with one or more embodiments, a device is configured to deliver localized curing energy along a pattern of curable material printed over a substrate.

In some embodiments, the curing energy is thermal energy.

In some embodiments, the curing energy is delivered in a heated gas.

In some embodiments, the heated gas includes a gas that promotes curing of the curable material.

In some embodiments, the curing energy is delivered in radiant form.

In some embodiments, the curing energy is delivered in a laser beam.

In some embodiments, a delivery location for the curing energy along the substrate is moveable with respect to the substrate

In some embodiments, the device is configured to simultaneously deliver localized curing energy to multiple discrete locations along the substrate.

In some embodiments, the device is configured to cool a portion of the substrate adjacent to a delivery location for the curing energy while the curing energy is being delivered.

In accordance with one or more embodiments, a curing device includes a curing head and a movement system. The curing head emits a column of curing energy along an emission axis and toward a substrate carrying a pattern of curable material. The movement system provides relative movement between the curing head and the substrate such that the column of curing energy is guided along the pattern.

In some embodiments, the curing head includes an emission tube having an emission end along the emission axis and an opposite end connected to a gas source. The column of curing energy is in the form of a heated gas.

In some embodiments, the curing head includes a heating element in the emission tube that heats a gas from the gas source as the gas flows through the tube to form the heated gas.

In some embodiments, the heated gas includes a gas that promotes curing of the curable material.

In some embodiments, the curing head includes a cooling port configured to direct a cooling gas at a portion of the substrate adjacent to a delivery location for the curing energy while the curing energy is being delivered.

In some embodiments, the curing head includes an insulator tube surrounding the emission tube and an outer tube surrounding the insulator tube. The cooling port is annular and defined between ends of the insulator tube and the outer tube, and an insulation gap is defined between the emission tube and the insulator tube.

In some embodiments, the curing device includes a laser arranged to emit a laser beam that includes the curing energy.

In some embodiments, wherein the curing head includes a cooling port configured to direct a cooling gas at a portion of the substrate adjacent to a delivery location for the curing energy while the curing energy is being delivered.

In some embodiments, the curing head is one of a plurality of curing heads. Each curing head is configured to emit a respective column of curing energy along a respective emission axis and toward the substrate. The movement system is configured to provide relative movement between each of the curing heads and the substrate such that each column of curing energy is guided along at least a portion of the pattern.

In some embodiments, the curing device is configured to selectively activate and deactivate curing energy associated with each of a plurality of curing heads such that the curing energy associated with each curing head is deactivated when the respective emission axis intersects a location of the substrate where no curable material is present.

In some embodiments, the curing device includes a print head configured to print the pattern of curable material. The print head and curing head move together relative to the substrate such that the column of curing energy follows the pattern of curable material as the curable material is printed.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

FIG. 1 is a perspective view of a cross-section of a curing head delivering thermal energy to a pattern of curable material printed on a substrate;

FIG. 2 is a perspective view of a cross-section of a curing head delivering radiant energy to a pattern of curable material printed on a substrate; and

FIG. 3 is a perspective view of a cross-section of multiple curing heads delivering curing energy to a pattern of curable material printed on a substrate.

### DESCRIPTION OF EMBODIMENTS

The device and method described below enables a printed material to be cured under conditions that the underlying substrate cannot normally withstand. For example, many functional inks require post-print curing at relatively high temperatures (e.g., 80° C. or higher). This effectively excludes the ability to print curable inks on materials with relatively low resistance to heat, such as most thermoplastic materials, when traditional curing methods such as ovens are employed. Many useful thermoplastic materials have a melting point (Tₘ), glass transition temperature (T_{g}), and/or stress-relaxation temperature too low (e.g., 200° C. or lower) to withstand functional ink curing temperatures without melting or otherwise deforming or undesirably changing shape.

As used herein, a functional ink is a printing fluid that provides a function other than coloration once solidified on the surface on which it is printed. Examples of such functions include electrical conductivity, dielectric properties, physical structure (e.g., stiffness, elasticity, or abrasion resistance), electromagnetic shielding or filtering, optical properties, electroluminescence, etc. The printing fluid may be considered a curable material once printed or otherwise deposited on the substrate.

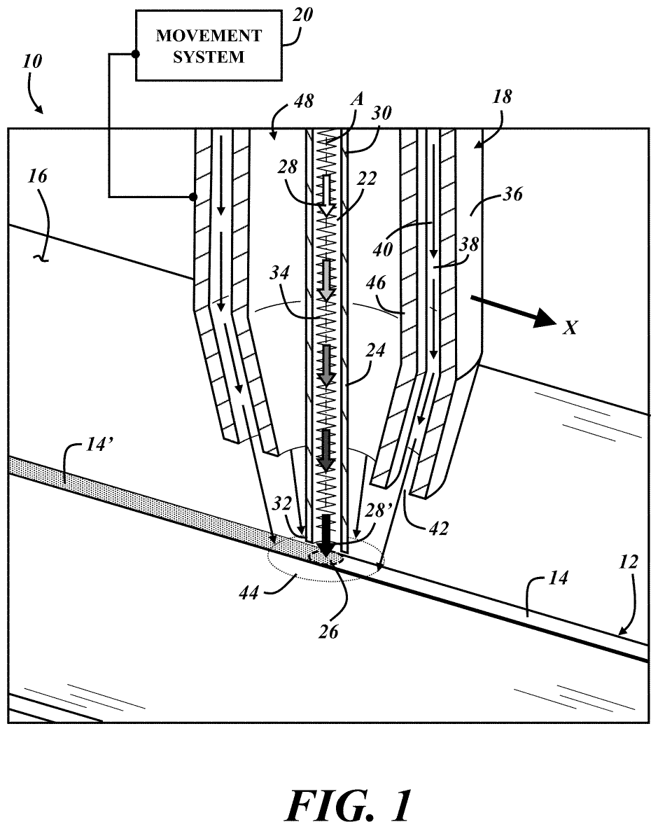

FIG. 1 illustrates part of an exemplary curing device 10 configured to deliver localized curing energy along a pattern 12 of curable material 14 printed over a substrate 16. The curable material 14 is considered to be patterned when a layer of the curable material is discontinuous over the substrate 16—i.e., when the curable material is present along a portion of that layer and not present along another portion of the layer. The types of curable materials contemplated here include any material that has been deposited on the substrate (e.g., by printing) that can be hardened, solidified, or at least further solidified from a semi-solid state by the addition of some form of curing energy. Different curing mechanisms include, for example, solvent evaporation, chemical reaction, sintering, or some combination of these and other mechanisms. The curing energy may take different forms, such as thermal energy or radiant energy. The effect of the curing energy may be to increase the temperature of the curable material 14 to a reaction initiation temperature or the accelerate an already initiated reaction. In some cases, the effect of the curing energy is to increase the temperature of the curable material 14 to accelerate solvent evaporation and/or to cause a binder material to activate to bind together solid particles of the curable material. In still other cases, the effect of the curing energy is to activate an initiator or catalyst in the curable material to polymerize and/or crosslink the curable material.

The illustrated device 10 includes a curing head 18 and a movement system 20, which is illustrated schematically. The curing device 10 may include other unillustrated components such as a base or support for the substrate 16, an electronic controller, a power supply, air pressure connectivity, user interface, etc. The movement system 20 is configured to provide relative movement between the curing head 18 and the substrate 16 such that an emission axis (A) of the curing head 18 can be guided along the patterned material 14. Multi-axis movement systems are generally known and may include axis-dedicated servos, guides, wheels, gears, belts, etc. The movement system 20 may be configured to move the curing head 18 back and forth along a single axis while the substrate is incrementally fed in a perpendicular direction after each pass of the curing head (e.g., in the manner of a printer), or the curing head 18 can be configured to move in any direction along a plane or three-dimensional contour while the substrate is held stationary. The curing head 18 and/or the substrate 16 may be configured for relative translational movement in up to all three Cartesian coordinate directions, for rotational movement about the associated axes, and for any combination of such movements to allow the curing device 10 to deliver curing energy in any direction and along any path on a substrate 16 of any shape. The curing head 18 could be affixed to the end of a robotic arm, for example.

For simplicity in explanation, the illustrated curing head 18 is shown moving in a single direction (X) over a continuous straight-line portion of the pattern 12 of curable material 14. In this example, the curable material 14 is printed on a flat substrate 16 in a previous operation before being presented to the curing device 10. The curing head 18 emits a column 22 of curing energy along the emission axis (A) and toward the substrate 16 and the pattern 12 of curable material 14, and the movement system 20 guides the column of curing energy along the pattern 12. In this example, the column 22 of curing energy is defined by the inner diameter of an emission tube 24 and intersects the substrate at a curing target 26, shown as a dashed line in FIG. 1. As the curing head 18 moves along the pattern 12 of curable material 14, it leaves cured or partially cured material 14′ behind where curing energy has already been locally delivered.

In the example of FIG. 1, the curing energy is delivered to the curable material 14 in the form of thermal energy in a gas 28. The gas 28 flows along the emission tube 24 from a first end 30 connected to a gas source (not shown) to a second or emission end 32. The gas 28 is heated as it passes through the tube 24, in this case via a resistance heater 34 located inside the tube. A jet or stream of heated gas 28′ is discharged from the emission end 32 of the tube and impinges the curing target 26 on the curable material. The temperature of the heated gas 28′ may be in a range from 100° C. to 300° C., for example. The gas 28 may be at least partially heated to the desired emission temperature before reaching the curing head 18. The tube 24 is made from a heat-resistant material (e.g., metallic or ceramic) and may itself be the heating element in some cases. The overall size is on the millimeter scale such that the tube 24 may have an inner diameter ranging from 0.5 mm to 10 mm, but this range is non-limiting.

The gas 28 may be air or any other suitable heat carrying gas. In some cases, the gas 28 includes one or more constituents that promotes curing of the curable material 14. In one example, the gas 28 includes nitrogen in an amount higher than atmospheric air, such as substantially pure nitrogen. Some functional inks rely partly on nitrogen to cure. In other examples, the gas 28 is at least partially an inert gas (e.g., argon), which may indirectly promote curing by excluding reactive gases like oxygen from the heated gas. The heated gas 28′ may include water vapor when the curable material 14 is a moisture-cure material.

The illustrated embodiment additionally includes an outer tube 36 surrounding the emission tube 24. The outer tube 36 partly defines a cooling gas channel 38 through which a cooling gas 40 flows and from which the cooling gas is discharged at a cooling port 42. In this particular example, the cooling gas channel 38 and the cooling port 42 have an annular cross-section that decreases in size toward the emission end 32 of the emission tube 24 such that the cooling gas 40 is discharged toward the substrate 16 in a direction with an radially inward component in a flow pattern that is partially conical. The cone of cooling gas 40 is directed at an area 44 of the substrate 16 adjacent and at least partially surrounding the curing target 26. The cooling gas 40 inhibits heat transfer to the substrate 16′ from the heated gas 28′ and from the heated material 14 in the curing target 26 and thus has the effect of further localizing the delivery of the curing energy to the curable material. The cooling gas 40 may be air, nitrogen, inert gas, or any other suitable gas. The temperature of the cooling gas 40 may be normal room temperature (e.g., 20-25° C.) or may be chilled below room temperature. The cooling discharge port 42 may have a different non-annular shape. For example, one or more pairs of cooling channels and ports may be transversely spaced apart (i.e., perpendicular to the X-direction) on opposite sides of the emission tube 24 to keep the substrate cooled during curing energy delivery while minimizing the cooling effect on the pattern of curable material 14.

In the example of FIG. 1, the annular cooling channel 38 and port 42 is further defined by an insulator tube 46. The insulator tube 46 is interposed between the emission tube 24 and the outer tube 36, surrounding the emission tube and surrounded by the outer tube. A radially inward surface of the outer tube 36 and a radially outward surface of the insulator tube 46 define and oppose each other across the cooling channel 38. A radial dimension of the cooling channel 38 and port 42 may be in a range between 0.5 mm and 5 mm. A portion of the emission tube 24 is housed within the insulator tube 46 such that a cavity 48 is formed therebetween. This cavity 48 can have multiple functions, including isolation of the heated emission tube 24 from the cooling channel 38 and housing of electrical wiring for the heating element 34. Heat loss is thus reduced for more efficient operation.

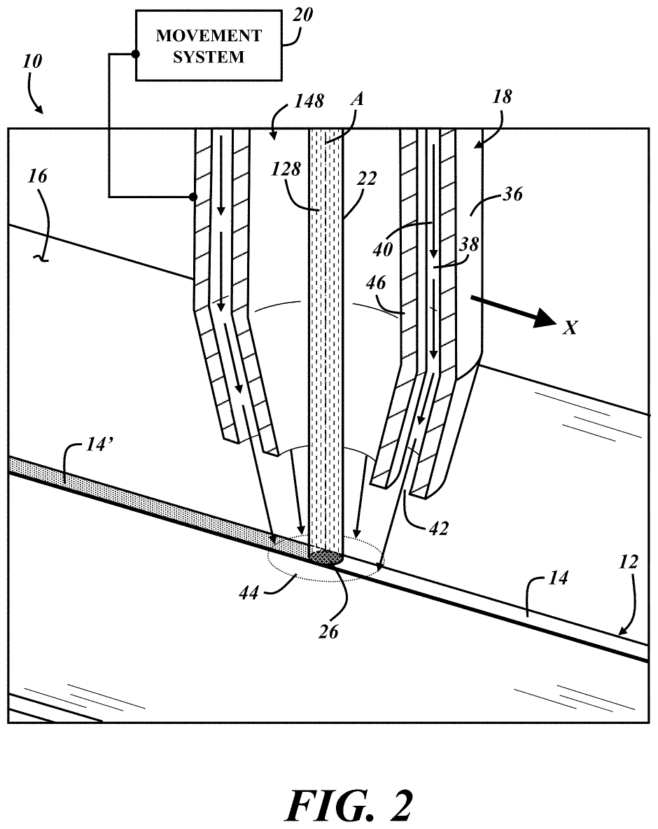

In the example of FIG. 2, the curing energy is in the form of radiant energy, such as infrared light. The radiant energy is delivered to and/or absorbed by the curable material 14, which may have the effect of heating the curable material at the curing target 26. In this example, the column 22 of radiant energy is in the form of a laser beam 128. The curing device 10 may thus further include a laser (not shown) that produces the laser beam 128. The laser may be a CO₂ or other type of laser that produces a laser beam 128 comprising light in the infrared portion of the spectrum. In this particular example, the emission tube of FIG. 1 is omitted, and the laser beam 128 propagates along the emission axis (A) through the cavity 148 defined within the insulator tube 46.

The cooling gas channel 38 and port 42 are substantially the same as in the previous example. In some embodiments, the column 22 of radiant energy propagates through the curing head 18 along an optical fiber and is emitted from an emission end of the fiber. In this and other embodiments employing curing energy in radiant form, the curing head 18 or curing device 10 may include mirrors or other optics to guide the radiant beam through the head and toward the substrate 16. Mirrors may be used, for example, to tilt the emission axis (A) and steer or guide the column 22 of curing energy in directions other than the direction of travel (X) of the curing head. 18. The curing target 26 may be more precisely defined when the curing energy is delivered radiantly, and the cooling gas 40 may be omitted in some cases. In some embodiments, the cooling gas channel is co-located with the laser beam 128 such that the laser beam propagates through a central cooling gas channel.

The device 10 may include a curing energy controller configured to regulate the amount of curing energy delivered to the substrate 16 at any particular time during a curing cycle. For example, the movement system 20 may operate in a scanning mode rather than a tracing mode. In the tracing mode, the movement system 20 guides the column 22 of curing energy along a continuous portion of the pattern 12 of curable material so that the curing energy is continuously delivered along the pattern. For example, if the line of the pattern 12 of curable material 14 in the figures followed a curved path, the movement system would follow the curved path with the curing energy being emitted constantly along the path. In the scanning mode, the movement system 20 moves the head 18 and/or substrate 16 consecutively along parallel adjacent lines. In this mode, the curing head 18 and its emission axis (A) will pass over areas of the substrate where the curable material 14 is not present—i.e., an opening in the pattern 12. The controller is configured to interrupt the emission of the curing energy while the emission axis is not passing through curable material so that the substrate 16 is not directly exposed to the curing energy.

In the case of radiant energy, the controller can be configured to interrupt or stop emission energy by cutting power to the energy source or selectively blocking, redirecting, or defocusing the light beam. The controller can also control the intensity of the energy in the beam by increasing and decreasing laser power either directly or via laser duty cycle or laser pulse width, for example. The controller can also vary curing energy delivery by communicating with the movement system 20 to increase or decrease the relative speed of movement between the substrate 16 and curing head 18. In the case of thermal curing energy as in the example of FIG. 1, the controller may selectively interrupt energy deliver by reducing or cutting power to the heating element or by actuating a valve to restrict, block, or redirect the flow of gas through the emission tube.

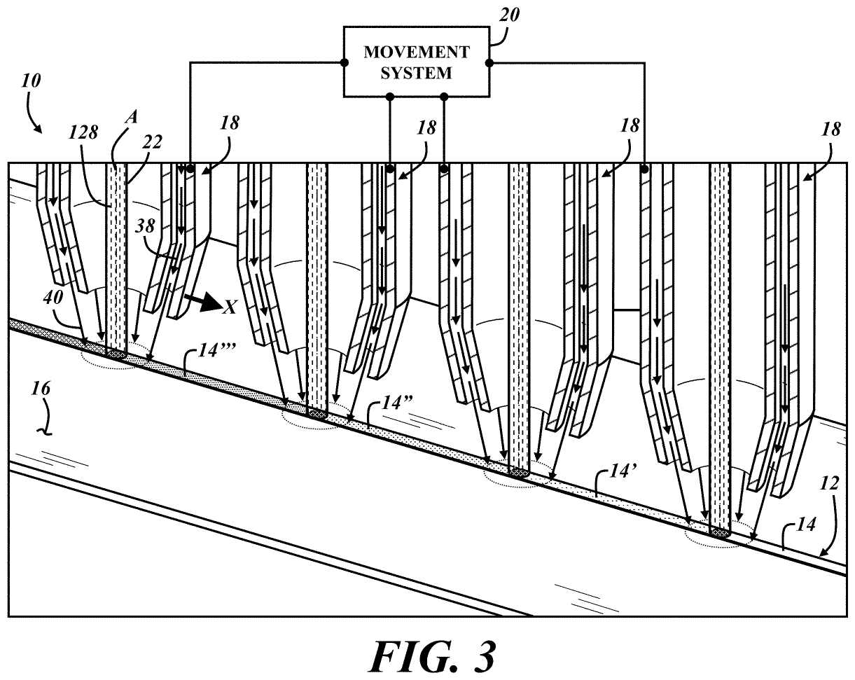

FIG. 3 illustrates part of a curing device 10 that includes multiple curing heads 18. The illustrated curing heads 18 are all substantially identical to that of FIG. 2, but other curing heads may be employed. The curing heads 18 are arranged in a single row in this example. In other examples, the curing heads 18 are arranged in an array. The example of FIG. 3 illustrates the plurality of curing heads 18 guiding their respective columns 22 of curing energy over the pattern 12 of curable material 14 in the X-direction. In this example, the curable material 14 is sequentially subjected to each of the plurality of columns of curing energy such that the curable material may be in four different degrees of cure (14′, 14″, 14″′). This is equivalent to a single curing head making four passes, for example, but the multiple heads reduce the total cycle time. Each of the multiple curing heads may be separately controllable to individually interrupt the emission of curing energy to avoid exposure of the substrate to the curing energy when passing outside the pattern. The illustrated configuration could alternatively be used in a scanning mode with the curing heads moving back and forth in the X-direction and indexing in a transverse direction after each X-direction movement is complete. With multiple (n) curing heads in a row as illustrated, each curing head will cover a corresponding portion (1/n) of the printed pattern 12 of curable material. In one embodiment, the device 10 includes multiple curing heads 18 arranged in an array and the array of curing heads is swept across the pattern 12 of curable material with each of column of curing energy being interrupted as it passes outside the pattern—i.e., over openings in the pattern where the substrate is exposed.

A method of curing a pattern 12 of curable material 14 includes the steps of providing the pattern of curable material over a substrate 16 and subsequently delivering localized curing energy along the pattern of curable material. This differs from traditional curing methods in that it does not involve soaking the entire substrate in an oven or chamber or otherwise raising the temperature of the substrate together with the temperature of the curable material. The localized delivery of curing energy thus enables printing of curable materials on low temperature substrate materials such as thermoplastics. In the above-described examples, the entire pattern 12 of curable material is printed or otherwise deposited over the substrate 16 prior to use of the curing device 10. For example, a separate printer may be used to deposit the curable material on the substrate according to a pre-programmed pattern, and then the substrate is moved to the curing device where the curing head follows the same pre-programmed pattern.

In another example, the device is a combined printing and curing device that includes both a print head and a curing head. The combined device can print the curable material on the substrate, and then the curing head can subsequently trace or scan the patterned material without moving the substrate to a different device. In still another example, the combined device prints the curable material with the print head, and the curing head follows behind the print head to deliver curing energy to the curable material at the same time the print head is depositing more curable material in its desired pattern. In such an embodiment, all of the curable material in the pattern is deposited for the same amount of time before being exposed to the curing energy.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Further, the term “electrically connected” and the variations thereof is intended to encompass both wireless electrical connections and electrical connections made via one or more wires, cables, or conductors (wired connections). Other terms are to be construed using their broadest reasonable meaning unless they are used in a context that requires a different interpretation.

1. A device configured to deliver localized curing energy along a pattern of curable material printed over a substrate.

2. The device of claim 1, wherein the curing energy is thermal energy.

3. The device of claim 2, wherein the thermal energy is delivered in a heated gas.

4. The device of claim 3, wherein the heated gas comprises a gas that promotes curing of the curable material.

5. The device of claim 2, wherein the thermal energy is delivered in radiant form.

6. The device of claim 5, wherein the radiant energy is delivered in a laser beam.

7. The device of claim 1, wherein a delivery location for the curing energy along the substrate is moveable with respect to the substrate.

8. The device of claim 1, further configured to simultaneously deliver localized curing energy to multiple discrete locations along the substrate.

9. The device of claim 1, further configured to cool a portion of the substrate adjacent to a delivery location for the curing energy while the curing energy is being delivered.

10. A curing device, comprising:
a curing head configured to emit a column of curing energy along an emission axis and toward a substrate carrying a pattern of curable material; and
a movement system configured to provide relative movement between the curing head and the substrate such that the column of curing energy is guided along the pattern.

11. The device of claim 10, wherein the curing head comprises an emission tube having an emission end along the emission axis and an opposite end connected to a gas source, the column of curing energy being in the form of a heated gas.

12. The device of claim 11, wherein the curing head further comprises a heating element in the emission tube that heats a gas from the gas source as the gas flows through the tube to form the heated gas.

13. The device of claim 11, wherein the heated gas comprises a gas that promotes curing of the curable material.

14. The device of claim 11, wherein the curing head further comprises a cooling port configured to direct a cooling gas at a portion of the substrate adjacent to a delivery location for the curing energy while the curing energy is being delivered.

15. The device of claim 14, wherein the curing head further comprises an insulator tube surrounding the emission tube and an outer tube surrounding the insulator tube, wherein the cooling port is annular and defined between ends of the insulator tube and the outer tube, and wherein an insulation gap is defined between the emission tube and the insulator tube.

16. The device of claim 10, further comprising a laser arranged to emit a laser beam comprising the curing energy.

17. The device of claim 16, wherein the curing head further comprises a cooling port configured to direct a cooling gas at a portion of the substrate adjacent to a delivery location for the curing energy while the curing energy is being delivered.

18. The device of claim 10, wherein the curing head is one of a plurality of curing heads, each curing head being configured to emit a respective column of curing energy along a respective emission axis and toward the substrate, and the movement system being configured to provide relative movement between each of the curing heads and the substrate such that each column of curing energy is guided along at least a portion of the pattern.

19. The device of claim 18, wherein the device is configured to selectively activate and deactivate the curing energy associated with each curing head such that the curing energy associated with each curing head is deactivated when the respective emission axis intersects a location of the substrate where no curable material is present.

20. The device of claim 10, further comprising a print head configured to print the pattern of curable material, wherein the print head and curing head move together relative to the substrate such that the column of curing energy follows the pattern of curable material as the curable material is printed.
